(19) United States
(12) Patent Application Publication
(10) Pub. No.: US 2026/0003554 A1
(43) Pub. Date: Jan. 1, 2026

(54) IMAGE COMMUNICATION APPARATUS, AND JOB SETTING METHOD

(71) Applicant: SHARP KABUSHIKI KAISHA, Sakai City (JP)

(72) Inventor: YUICHI NISHII, Sakai City (JP)

(21) Appl. No.: 19/243,028

(22) Filed: Jun. 19, 2025

(30) Foreign Application Priority Data
Jun. 28, 2024 (JP) 2024-105260

(51) Int. Cl. G06F 3/12

(52) U.S. Cl. CPC G06F 3/1257; G06F 3/1206; G06F 3/1273; G06F 3/1285

(57) ABSTRACT

An image communication apparatus includes one or more job controllers that control execution of a job of transmitting image data based on a setting made by a user in a communication method selected by the user from a plurality of communication methods, a history storage processor that stores a history of an executed job in a memory, a setting applier that accepts selection of any one of histories and applies a setting included in the selected history to a new execution job to enable the job to be executed, and a setting manager that accepts, from a specific user, a job prohibition setting to prohibit execution of the job in any of the communication methods, in which, when any history is selected even if the job prohibition setting has been established, the setting applier applies the setting included in the history to enable the new execution job to be executed.

### FIELD OF THE INVENTION

The disclosure relates to an image communication apparatus and a job setting method, and more particularly to an image communication apparatus and a job setting method having a function of storing a history of executed jobs and applying settings included in the stored history to settings of a job to be executed (to be newly executed).

### BACKGROUND ART

There is known an image forming apparatus that can execute a job (transmission job) of transmitting data to another apparatus using a plurality of communication methods (transmission methods) such as a data transmission function using electronic mails and a file transmission function, when the image forming apparatus succeeds in user authentication. In addition, there is known an image forming apparatus in which, when the apparatus succeeds in user authentication, a transmission history (a history of transmitted transmission jobs and the like) accumulated in the image forming apparatus can be referred to, and a new transmission job can be set with reference to the transmission history. However, it is not preferable in terms of security that history information about the transmission job performed by a user who successfully authenticated be viewed by other users. Therefore, a communication apparatus has been proposed that, when reference to transmission history information is instructed, determines whether to permit reference to the transmission history information in accordance with a setting of availability of each transmission method and a transmission destination included in the transmission history information. With respect to settings of availability of a transmission method, there are known settings of not only permitting/prohibiting each transmission method, but also permitting reference to all transmission destinations or permitting reference only to the destination related to the authenticated user when the transmission method is permitted.

### SUMMARY

### Technical Problem

Normally, only an administrator or a user having an authority equivalent to that of the administrator (hereinafter, also referred to as an “administrative user” in this specification) can set permission/prohibition of a job using any one of a plurality of communication methods (transmission methods). However, such a job can be executed not only by the administrative user but also by a general user (a user having no administrative rights). It is conceivable that, when the administrative user prohibits a job performed by using any communication method, the use of the history including a setting for the prohibited job is also prohibited. However, recording a history indicates that a job related to the history has been performed recently, and it is likely that the history can be referred to and used when setting a new job. If the administrative user makes a prohibition setting for the transmission method and the destination of such a job for security reasons, for example, general users may perceive this setting as a sudden restriction that prevents the job from using the previously allowed communication method. If transmission methods or destinations that general users have frequently used, for example, for routine tasks, are prohibited without the general users' knowledge, it may lead to delays in the tasks of the general users and cause confusion. This disclosure has been made in view of the above circumstances, and is intended to prevent user confusion by enabling a job to be performed when a setting included in a history is applied to a setting of the job to be performed even if use of a transmission method or a transmission destination is prohibited.

### Solution to Problem

This disclosure is to provide an image communication apparatus including a job controller that controls execution of a job of transmitting image data based on a setting made by a user in a communication method selected by the user from a plurality of communication methods, a history storage processor that stores a history of an executed job in a memory, a setting applier that accepts selection of any one of histories and applies a setting included in the selected history to a new execution job to enable the job to be executed, and a setting manager that accepts, from a specific user, a job prohibition setting to prohibit execution of the job in any of the communication methods, in which the setting applier applies, when any history is selected even if the job prohibition setting has been established, the setting included in the history to enable the new execution job to be executed.

In addition, the disclosure based on a different point of view is to provide a job setting method used by a controller that controls an image communication apparatus, the job setting method including controlling execution of a job of transmitting image data based on a setting made by a user in a communication method selected by the user from a plurality of communication methods, storing a history of an executed job in a memory, accepting selection of any one of histories and applying a setting included in the selected history to a new execution job to enable the job to be executed, accepting, from a specific user, a job prohibition setting to prohibit execution of the job in any of communication methods, in which when any history is selected even if the job prohibition setting has been established, in applying the setting, the setting included in the history is applied to enable the new execution job to be executed.

### Advantageous Effects of Disclosure

In the image communication apparatus according to the disclosure, when any history is selected even if the job prohibition setting has been established, the setting applier applies the setting included in the history to enable the job to be executed, and thus, even if the use of the transmission method or the transmission destination is prohibited, the setting included in the history is immediately applicable to the setting of the job. Therefore, it is possible to reduce confusion of the user who does not know the establishment of the prohibition setting, compared to when the setting included in the history is not immediately applicable to the setting of the job.

The job setting method according to this disclosure also exhibits the same effects and advantages.

### BRIEF DESCRIPTION OF THE DRAWINGS

FIG. 1 is a descriptive diagram illustrating an example of the appearance of a multifunction peripheral as an image communication apparatus according to an embodiment of the disclosure.

FIG. 2 is a descriptive diagram illustrating an example of a configuration of the image communication apparatus illustrated in FIG. 1.

FIG. 3 is a descriptive diagram illustrating an example of a screen for accepting a job prohibition setting in the image communication apparatus illustrated in FIG. 2.

FIG. 4 is a descriptive diagram illustrating an example of a screen for accepting a job prohibition setting, which is different from that illustrated in FIG. 3.

FIG. 5A is a descriptive diagram illustrating an example of an image transmission basic screen for accepting a setting of a scan job as a transmission job.

FIG. 5B is a descriptive diagram illustrating another example of the image transmission basic screen illustrated in FIG. 5A.

FIG. 6 is a descriptive diagram illustrating an example of a screen for selecting a destination registered in an address book on the image transmission basic screen illustrated in FIG. 5A.

FIG. 7 is a descriptive diagram illustrating an example of a screen for selecting a transmission job for applying a selected destination on the destination selection screen illustrated in FIG. 6.

FIG. 8 is a descriptive diagram illustrating an example of a history display screen displayed when “recent job” button is touched on the image transmission basic screen illustrated in FIG. 5A.

FIG. 9 is a descriptive diagram illustrating a state in which a history selected on the history display screen illustrated in FIG. 8 has been called and a registered destination has been applied.

FIG. 10 is a descriptive diagram illustrating an example of a message about a job prohibition setting displayed on the image transmission basic screen illustrated in FIG. 9.

FIG. 11 is a descriptive diagram illustrating an example of a screen for setting an available period according to a second embodiment.

FIG. 12 is a descriptive diagram illustrating an example of a message about a job prohibition setting displayed on the image transmission basic screen according to the second embodiment.

FIG. 13 is a descriptive diagram illustrating an example of a screen for setting a deadline according to a third embodiment.

FIG. 14 is a descriptive diagram illustrating an example of a message about a job prohibition setting displayed on the image transmission basic screen according to the third embodiment.

FIG. 15 is a descriptive diagram illustrating an example of a screen for setting the number of available times according to a fourth embodiment.

FIG. 16 is a descriptive diagram illustrating an example of a message about a job prohibition setting displayed on the image transmission basic screen according to the fourth embodiment.

FIG. 17 is a descriptive diagram illustrating an example of a screen for setting a permission application to an administrative user according to a fifth embodiment.

FIG. 18 is a descriptive diagram illustrating an example of a message about a job prohibition setting displayed on the image transmission basic screen according to the fifth embodiment.

FIG. 19 is a flowchart related to a setting adaptation process, illustrating an example of processing performed by a controller 12 in the first embodiment.

FIG. 20 is a flowchart related to a history storage process, illustrating an example of processing performed by the controller 12 in the first embodiment.

FIG. 21 is a flowchart related to a setting adaptation process, illustrating an example of processing performed by the controller 12 in the second embodiment, different from that in FIG. 19.

### DESCRIPTION OF EMBODIMENTS

The disclosure will be described below in further detail with reference to the drawings. Note that the following description is in all aspects illustrative, and it should not be understood that the description restricts the disclosure.

### Configuration of Image Communication Apparatus

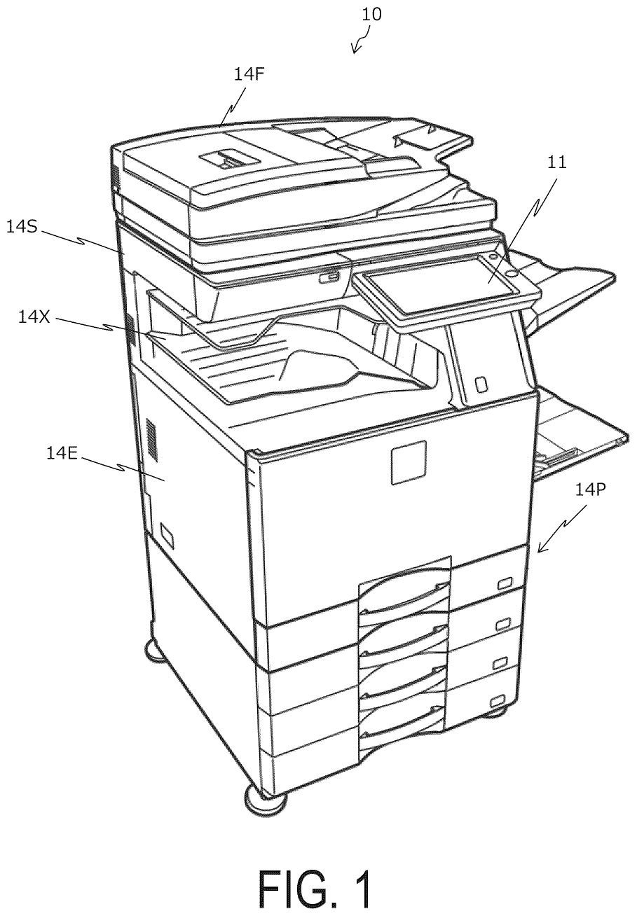

FIG. 1 is a descriptive diagram illustrating an example of appearance of an image communication apparatus according to the present embodiment. FIG. 1 illustrates a multifunction peripheral as an example of the image communication apparatus.

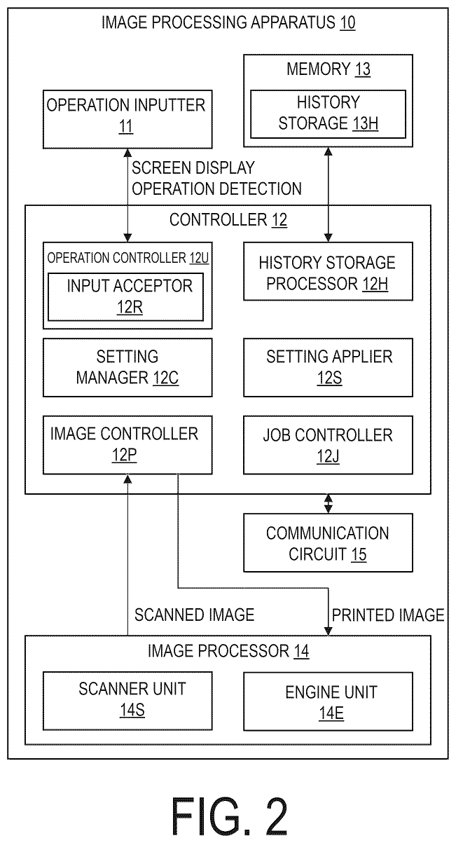

FIG. 2 is a descriptive diagram illustrating an example of a configuration of the image communication apparatus illustrated in FIG. 1.

The image communication apparatus 10 includes an operation inputter 11, a scanner unit 14S, a document feeding device 14F, an engine unit 14E, a feeder 14P, and a sheet discharger 14X as illustrated in FIG. 1. In addition, the image communication apparatus 10 further includes a controller 12, a memory 13, and a communication circuit 15 as illustrated in FIG. 2. The controller 12 includes an operation controller 12U, a setting manager 12C, an image controller 12P, a history storage processor 12H, a setting applier 12S, and a job controller 12J. The memory 13 includes a history storage 13H. The image communication apparatus 10 further includes an image processor 14 including a scanner unit 14S and an engine unit 14E, which are also illustrated in FIG. 1.

The controller 12 is configured mainly by one or more processors and one or more memories as hardware resources. The processor executes the control program stored in the memory, and thereby the functions of the operation controller 12U, the setting manager 12C, the image controller 12P, the history storage processor 12H, the setting applier 12S, and the job controller 12J described above are implemented. The respective elements included in the controller 12 will be described.

The operation controller 12U controls display of the operation inputter 11 and processes user operations detected by the operation inputter 11. The operation controller 12U may include an input acceptor 12R. The input acceptor 12R accepts a setting related to a job controlled by the job controller 12J, which will be described below, by any of a plurality of input methods that the unit can adopt. The setting manager 12C accepts a setting (job prohibition setting) for prohibiting a specific type of job from the administrative user. The image controller 12P controls operations of the scanner unit 14S and the engine unit 14E and processing related to the image data. The history storage processor 12H stores the settings related to the executed job in the history storage 13H as a job history and performs processing of calling a stored history in response to a user operation. That is, if no job prohibition setting has been established for a job to be executed, the job is stored as a history in the history storage 13H. On the other hand, it may be designed that if a job prohibition setting has been established for the job, the job will not be stored in the history storage 13H as a history even if the job is executed.

When the operation controller 12U accepts selection of any of the histories stored in the history storage 13H, the setting applier 12S applies the setting included in the selected history to a job to be executed to make the job executable. Regardless of whether a prohibition setting has been established for a job to be executed, the setting included in a selected history is applied to the job to be executed (new execution job) to make the job executable. The job controller 12J controls execution of a job related to image data. Examples of the job related to the image data include a copy job for reading an image document and printing the image data, a scan job for reading a document and transmitting the image data to the outside or storing the image data in the memory 13, and a print job for developing print data received from the outside and printing the image data. Although a transmission job for transmitting image data to the outside includes the above-described scan job, the job is not limited thereto, and for example, a job for transmitting image data stored in the memory 13 to the outside is also included in the transmission job.

There are several types of communication methods used when a transmission job is transmitting image data to the outside. For example, there is an e-mail transmission job for transmitting image data as data attached to an e-mail. There is also a File Transfer Protocol (FTP) transmission job for transmitting image data using the FTP method. There is also a desktop transmission job for transmitting image data to a desktop such as a personal computer (PC). In addition, there is a shared folder job for transmitting image data to a folder set in advance as a shared folder with an external device. In this specification, a communication method is also referred to as a mode. There is also an external memory device storage job for transmitting image data to a USB memory device connected to a USB connector, which is not illustrated in FIG. 1. Alternatively, there is a remote PC scan job for reading an image of a document by operating a scanner with a remote operation from a PC connected via the communication circuit 15. Furthermore, there is a fax transmission job for transmitting image data in a fax (facsimile) communication method.

The memory 13 is configured as a combination of a random access memory (RAM) and a nonvolatile memory that can be accessed from the controller 12. A double-data-rate synchronous dynamic random access memory (DDR SDRAM) such as DDR4 or DDR5 may be employed for the RAM. A solid state disk (SSD) or a hard disk drive (HDD) may be employed for the nonvolatile memory. At least a part of the hardware of the memory of the controller 12 and the memory 13 may be shared. The history storage 13H is a storage area of the memory 13 for storing job histories. The history storage 13H stores histories of a finite number of jobs in a first-in-first-out manner. That is, if the volume of the history storage 13H is full of histories being stored when storing a new history, the new history will be stored by sequentially deleting older histories. According to the present embodiment, if a specific user establishes a prohibition setting with respect to execution of a job (job prohibition setting) in any communication method of a plurality of communication methods, the history storage processor can prevent the job related to the communication method for which the job prohibition setting has been established from being stored as a history, thus the history of the job related to the communication method for which the prohibition setting has been established will not be included in the history stored in the memory in the first-in-first-out manner, and therefore the effect of the job prohibition setting becomes apparent. Moreover, after the job prohibition setting, instead of immediately applying the setting included in the history to the job setting, as long as there is a history of the job in the communication method related to the job prohibition setting, the setting included in the history can be applied to the job setting, and therefore, the prohibition setting is reflected gradually.

The operation inputter 11 includes a display device (display) such as a liquid crystal display (LCD) or an organic light emitting display (OLED) that provides an operation screen for states or operations of the image communication apparatus 10 to a user, and an input detection device such as a touch panel that detects user operations. The operation inputter 11 is also a display that displays the operation screen and accepts user operations.

The scanner unit 14S and the engine unit 14E constituting the image processor 14 will be described. The scanner unit 14S is, for example, a scanner, and portion that includes a mechanism, a circuit, and an image sensor for scanning and reading a document and reads documents. The document feeding device 14F illustrated in FIG. 1 is included in the scanner unit 14S. The engine unit 14E includes a mechanism and a circuit for performing charging, exposing, developing, transferring, and fixing in an electrophotographic system in the present embodiment, a paper feed tray for storing printing paper, and a paper feed conveyance mechanism for feeding and conveying the stored printing paper, and performs printing. The electrophotographic method is an example, and printing may be performed by using another method.

The scanner unit 14S (scanner) of the image communication apparatus 10 reads an image of a document under control of the job controller 12J, and converts the image into an image signal. That is, the image communication apparatus 10 reads a document to generate image data in a copy job, a facsimile transmission job, and a scan job. The scanner unit also receives print data from an external device via the communication circuit 15 to generate image data for printing. The engine unit 14E performs printing on a sheet stored in the feeder 14P based on the image data, and discharges a printed sheet to the sheet discharger 14X.

The communication circuit 15 is a circuit for communicating with an external apparatus through wired communication of Ethernet, etc. or wireless communication of a wireless LAN, Bluetooth (registered trademark), etc.

### Prohibition Setting by Setting Manager and Setting of Destination Using History

### First Embodiment

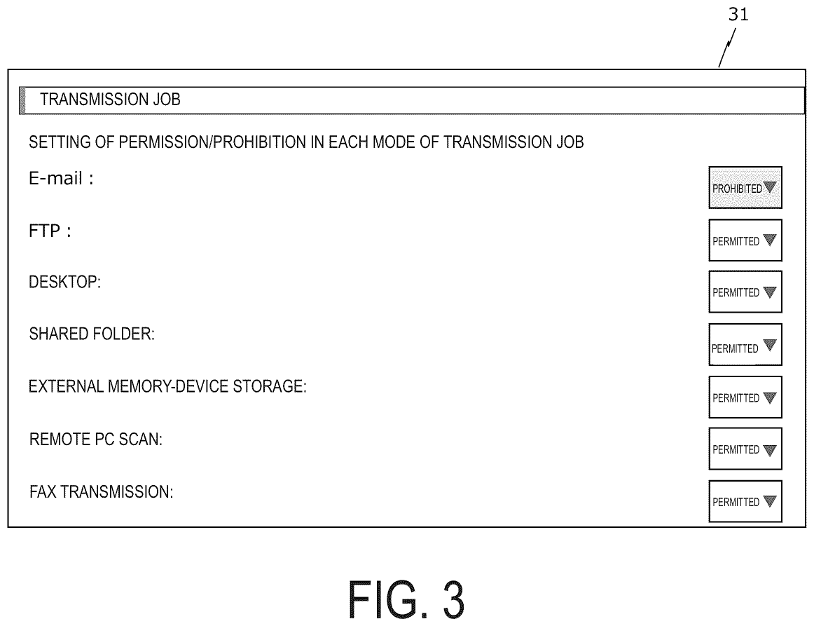

Next, an example of a prohibition setting accepted by the setting manager 12C will be described. FIG. 3 is a descriptive diagram illustrating a screen on which the setting manager 12C of the image communication apparatus 10 illustrated in FIG. 2 accepts a job prohibition setting through the operation inputter 11. A job restriction screen 31 illustrated in FIG. 3 is displayed when a user logs in using the administrative rights of the image communication apparatus 10. That is, only the administrative user can establish settings on the screen. As illustrated in FIG. 3, the administrative user can set permission or prohibition for each of all transmission jobs that can be executed by the image communication apparatus 10 by using the job restriction screen 31. In the example illustrated in FIG. 3, permission or prohibition can be set for each of an e-mail transmission job, an FTP transmission job, a desktop transmission job, a shared folder job, an external memory device storage job, a remote PC scan job, and a fax transmission job. In the example illustrated in FIG. 3, while prohibiting an e-mail transmission job is set, and other jobs are set to be permitted. The job prohibition setting illustrated in FIG. 3 is applied to any user who uses the image communication apparatus 10, and therefore, no user can execute an e-mail transmission job using the image communication apparatus 10. However, when a history of an e-mail transmission job is stored in the history storage 13H, the history is called and applied as a setting for a new-execution e-mail transmission job to be newly executed, and thereby an e-mail transmission job can be executed.

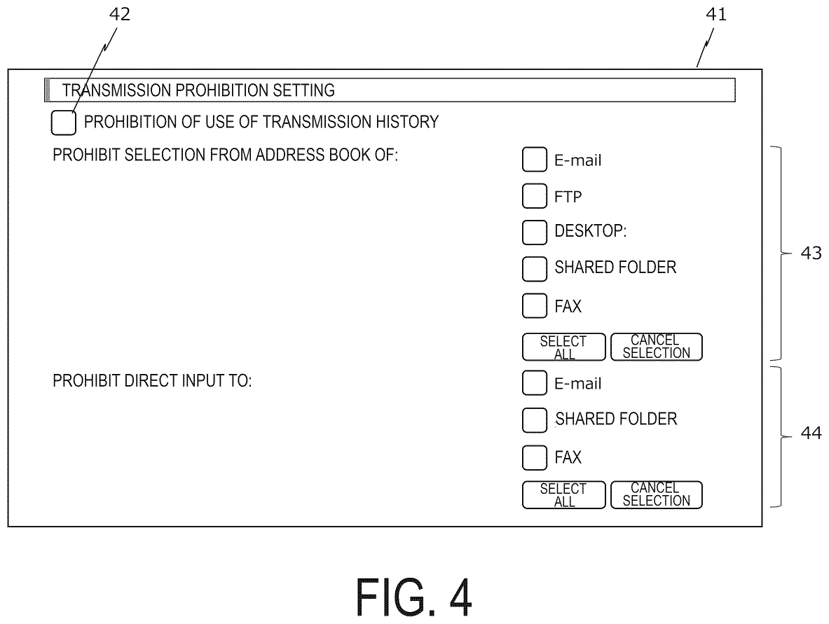

Another example of the prohibition setting accepted by the setting manager 12C will be described. FIG. 4 is a descriptive diagram illustrating an example of a screen different from that in FIG. 3, on which the setting manager 12C accepts a job prohibition setting via the operation inputter 11. The screen illustrated in FIG. 4 is an input method restriction screen 41 for restricting an input method of a transmission destination (destination). Similarly to the job restriction screen 31 of FIG. 3, the input method restriction screen 41 is a screen on which only an administrative user can make settings. The input method restriction screen 41 may be configured to allow each authenticated user who has succeeded in user authentication to make individual settings. In the example illustrated in FIG. 4, permission or prohibition can be set for each of three input methods. The first input method is a method of inputting a transmission destination (destination) using a transmission history. The transmission history is different from the history of jobs stored in the history storage 13H. The job history is mainly intended to keep a history of jobs executed, in which job settings or transmitted image data are stored as histories. The function of applying the history to the setting of a new execution job to be executed can be described as a derivative function. On the other hand, the transmission history is a function of storing a transmission destination, calling the stored destination, and using the destination for a new execution job to be executed. The input method restriction screen 41 includes a transmission history input prohibition setting 42 for prohibiting an input method using a transmission history. As described above, the controller 12 causes the operation inputter 11 to display the job restriction screen 31 or the input method restriction screen 41 as the operation controller 12U, and accepts the settings. In addition, an operation screen similar to the job restriction screen 31 and the input method restriction screen 41 may be displayed on a PC or the like connected via the communication circuit 15, and an operation of the user who has logged in with administrative rights may be accepted.

The second input method is an input method of selecting a transmission destination (destination) from an address book. The address book is a database in which destinations related to transmission jobs are registered in advance. The input method restriction screen 41 includes an address book input prohibition setting 43 for prohibiting any destination registered in the address book from being selected and applied to the destination of the transmission job. In the example illustrated in FIG. 4, the address book input prohibition setting 43 accepts a prohibition setting for each communication method of a transmission job. The third input method is an input method of directly inputting a transmission destination (destination). The destination is directly input by using an external keyboard, a mobile terminal connected for communication, or the like, in addition to a software keyboard displayed on the operation inputter 11. The input method restriction screen 41 includes a direct input prohibition setting 44 for prohibiting direct input of destinations. In the example illustrated in FIG. 4, the direct input prohibition setting 44 accepts a prohibition setting for each communication method of transmission jobs.

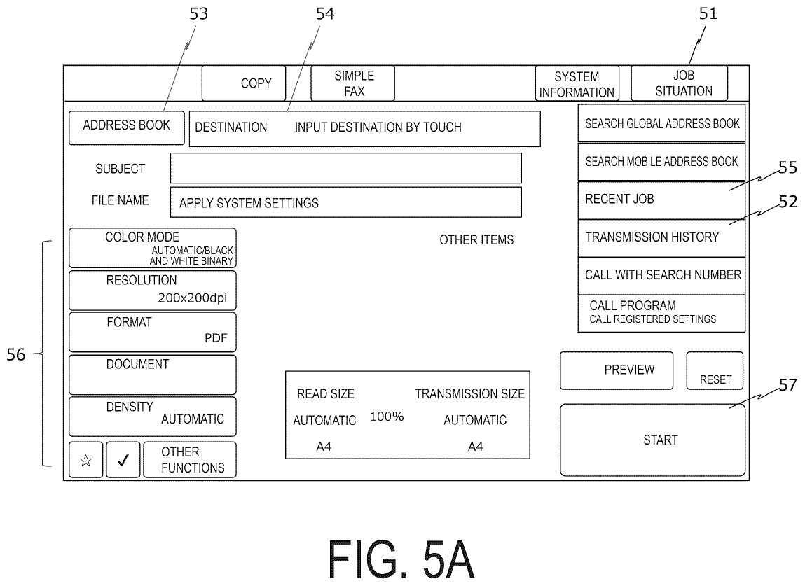

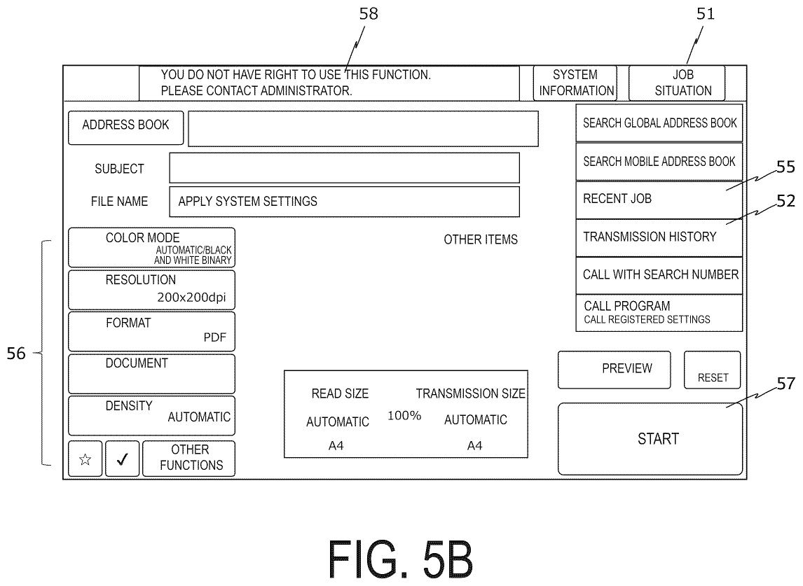

As an example, a setting of a transmission job when prohibiting an e-mail transmission job has been set as illustrated in FIG. 3 will be described. FIG. 5A to FIG. 7 are descriptive diagrams illustrating examples of operation screens for accepting settings of scan jobs as transmission jobs. The diagrams are of examples of operation screens displayed on an operation inputter 11. FIG. 5A illustrates an example of an image transmission basic screen 51 for accepting settings of a scan job. The image transmission basic screen 51 displays a plurality of input method options for setting a destination. A “transmission history” button 52 for selecting and setting a destination from a list of transmission histories is arranged on the right side of the image transmission basic screen 51. When the “transmission history” button 52 is touched, the controller 12 as the operation controller 12U causes the operation inputter 11 to display a list screen (not illustrated) of destinations (transmission histories) used (set) in the transmission jobs that have already been executed. When the user selects any of the listed destinations, the controller 12 accepts the destination as a setting for the transmission job.

An “address book” button 53 for setting a destination using an address book is arranged at the upper left part of the image transmission basic screen 51. When destination selection from the address book is set to be prohibited in all the communication methods on the input method restriction screen 41 illustrated in FIG. 4, the “address book” button 53 may be grayed out or may be hidden.

A destination field 54 for directly inputting a destination using a software keyboard or the like, not illustrated in FIG. 5A, is arranged near the right side of the “address book” button 53. When the destination field 54 is touched, the controller 12 as the operation controller 12U accepts a direct input for a destination using a software keyboard, an external keyboard, a mobile terminal, or the like. When the direct input for the e-mail transmission job is set to be prohibited on the input method restriction screen 41, the user may be notified of the fact that the operation of the direct input is not accepted by displaying a message indicating that the user does not have the authority to directly input the destination, etc. When a setting to prohibit an e-mail transmission job is established, “input destination by touch” shown in the destination field in FIG. 5A may not be displayed. Furthermore, as another pattern illustrated FIG. 5A, when a setting to prohibit an e-mail transmission job is established, a message 58 stating “You do not have the right to use this function. Please contact the administrator” may be displayed on the image transmission basic screen 51 as illustrated in FIG. 5B. Although the message 58 is displayed in the upper part of the image transmission basic screen 51 in FIG. 5B, the display position is not limited to this, and the message 58 may be displayed overlapping the image transmission basic screen 51. When the destination field 54 is touched in FIG. 5B, the user may be notified of the fact that the operation of direct input is not accepted by making a beep sound indicating that the operation is disabled and/or displaying a message indicating that the user does not have the authority to directly input a destination. In the destination field 54, not only a destination directly input but also a destination set using a transmission history, an address book, a history to be described below, and the like is displayed. In addition, when a destination list screen, which is not illustrated, is displayed by touching the “transmission history” button 52 in FIG. 5B, it is preferable that the message 58 be hidden, but the message 58 may be displayed on the destination list screen.

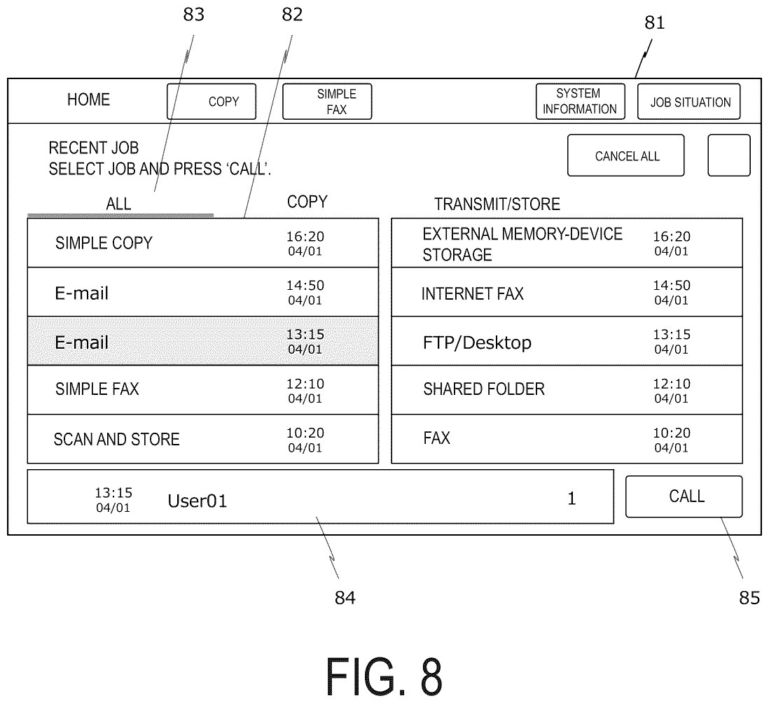

Furthermore, a “recent job” button 55 for selecting a job history and setting a destination included in the history is arranged on the right side of the image transmission basic screen 51. The “transmission history” button 52, the “address book” button 53, and the direct input accept only the setting of a destination. On the other hand, when the “recent job” button 55 is touched and any of the history settings on the history display screen (see FIG. 8) to be described below is applied, the selected history setting is applied to the items other than the destination. After the destination of the transmission job is set from the history, any input method may be accepted for the operation of setting an additional destination. Alternatively, the operation of setting an additional destination may be accepted only from the history.

In addition, a job setting area 56 for accepting a setting of image quality and the like related to a scan job is arranged at the left part of the image transmission basic screen 51. A “start” button 57 for accepting an instruction to start a transmission job is arranged at the bottom right part of the image transmission basic screen 51. The controller 12 as the operation controller 12U sets the “start” button 57 to an operation-disabled state until the destination is set. To let the user know the operation-disabled state, the “start” button 57 may be grayed out until the destination is set. In addition to setting of the destination, the “start” button 57 may be grayed out until the document is set. When the message 58 is displayed on the destination list screen displayed by touching the “transmission history” button 52 in FIG. 5B, the “start” button 57 may be kept in grayed-out display even after destination setting.

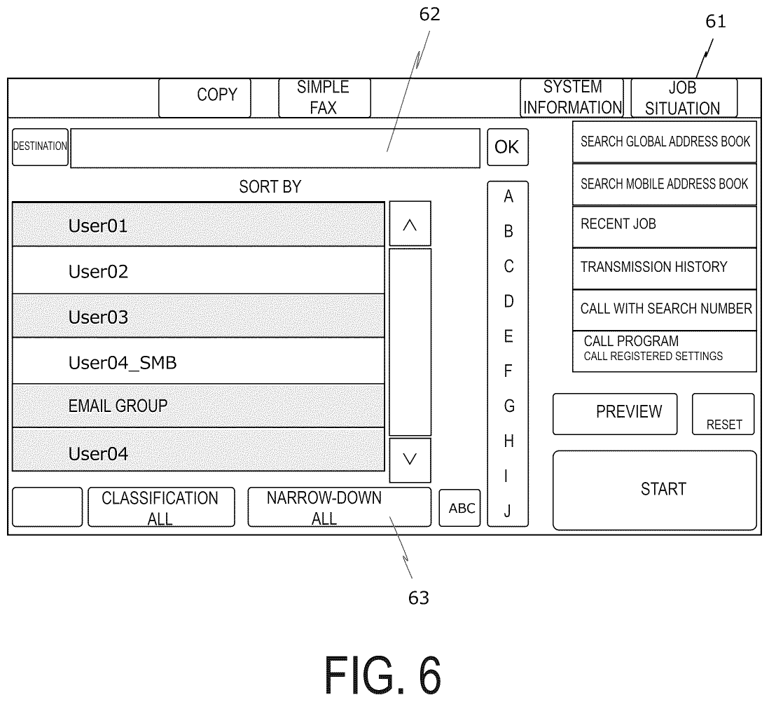

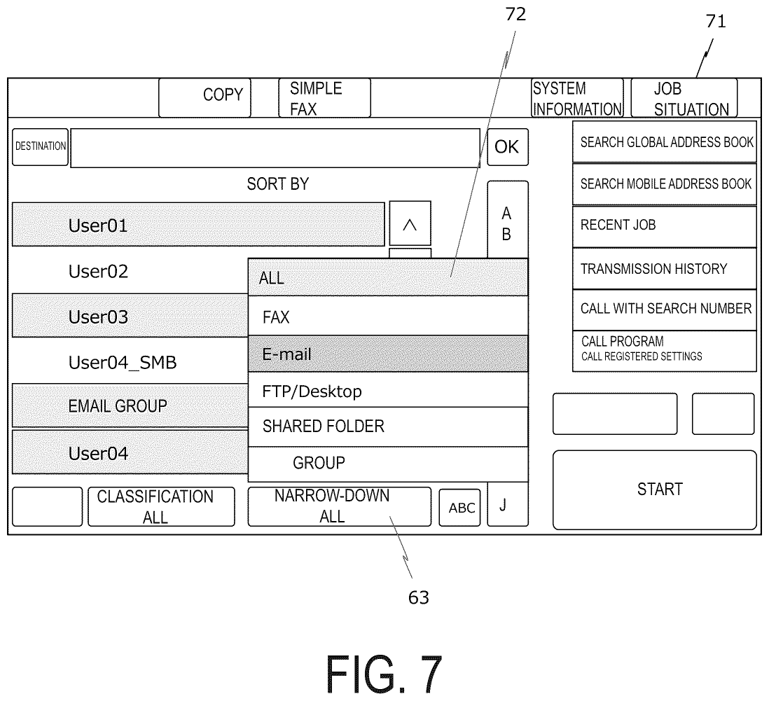

For example, when the user touches the “address book” button 53 to set a destination, the controller 12 as the setting applier 12S causes a destination selection screen 61 illustrated in FIG. 6 to be displayed. The destination selection screen 61 is displayed by overlaying an address book display area 62 on a part of the image transmission basic screen 51 illustrated in FIG. 5A. In the address book display area 62, a plurality of destinations registered in the address book are displayed. However, since the setting to prohibit the e-mail transmission job has been established in this example, the destination related to the e-mail transmission job, that is, the destination of which only the email address has been registered, is grayed out, and cannot be selected. In the address book, different destination data corresponding to transmission jobs in different modes can be registered with one destination. This is because destination data may be registered in each mode so that data can be transmitted to the same destination in different modes. When a selected destination includes a plurality of pieces of destination data, the controller 12 serving as the setting applier 12S causes a transmission mode selection screen for selecting destination data corresponding to a transmission job in any mode as illustrated in FIG. 7 to be displayed.

For example, when “User04_SMB” is selected as a destination in FIG. 6 and a “narrow-down_all” button 63 is touched, a transmission mode selection screen 71 illustrated in FIG. 7 is displayed. The transmission mode selection screen 71 includes a mode (communication method) selection area 72. The mode selection area 72 illustrated in FIG. 7 is an example in which four pieces of destination data corresponding to different modes are registered in the selected destination and selection of any one of the four pieces of destination data is accepted. Four types of data, that is, destination data of a fax transmission job, destination data of an e-mail transmission job, destination data common to an FTP transmission job and a desktop transmission job, and destination data of a shared folder are registered. However, since the setting to prohibit e-mail transmission jobs has been established, the destination data related to the e-mail transmission job is grayed out and thus not selectable. When any mode except e-mail transmission jobs is selected, the destination data corresponding to the mode and registered in the address book is applied as a destination. The destination is displayed in the destination field 54 illustrated in FIG. 5A. When a “start” button 57 is touched with the destination displayed in the destination field 54, the controller 12 serving as the job controller 12J applies the setting of the job setting area 56 and causes the image controller 12P to read the document set in the scanner unit 14S. Then, image data of the document is generated and transmitted to the applied destination.

On the other hand, when the user touches a “recent job” button 55 to set a destination, the setting applier 12S causes a history of jobs stored in the history storage 13H to be displayed as an operation screen. FIG. 8 is a descriptive diagram illustrating a screen of a history (history screen) displayed on the operation inputter 11. As illustrated in FIG. 8, a history display area 82 for displaying a history of jobs, a job type selection unit 83, a selected history display area 84 for displaying a selected history, and a “call” button 85 for calling the selected history and applying the selected history to a destination are arranged on the history screen 81. In FIG. 5B, when the history screen 81 is displayed by touching the “recent job” button 55, the message 58 is hidden. The job type selection unit 83 accepts the type of history to be displayed in the history display area, and selectable job types are three types including “copy”, “transmission/storage”, and “all”. The type “copy” is to display a history of a copy job, and the type “transmission/storage” is to display a history of a transmission job and a history of a job of storing image data in the memory 13. The type “all” is to display both types (history of all jobs), and the example of FIG. 8 illustrates a state in which “all” have been selected as an example. Histories are displayed in two rows, left and right, in the history display area 82. When any of the displayed histories is touched, the selection of the history is accepted, and the content registered in the selected history is displayed in the selected history display area 84. In the example of FIG. 8, the history of an e-mail transmission job has been selected, and the background of the selected history is grayed out. In the selected history display area 84, one destination registered in the selected history, “User01”, is displayed. Although the setting to prohibit the e-mail transmission job has been made, the history of the e-mail transmission job can be selected. When the “call” button 85 is touched, the settings for the destination and the like of the selected history are applied to the destination and the like of the transmission job whose settings have been accepted in FIG. 5A. The “call” button 85 may be grayed out, for example, so as not to accept an operation before a history is selected.

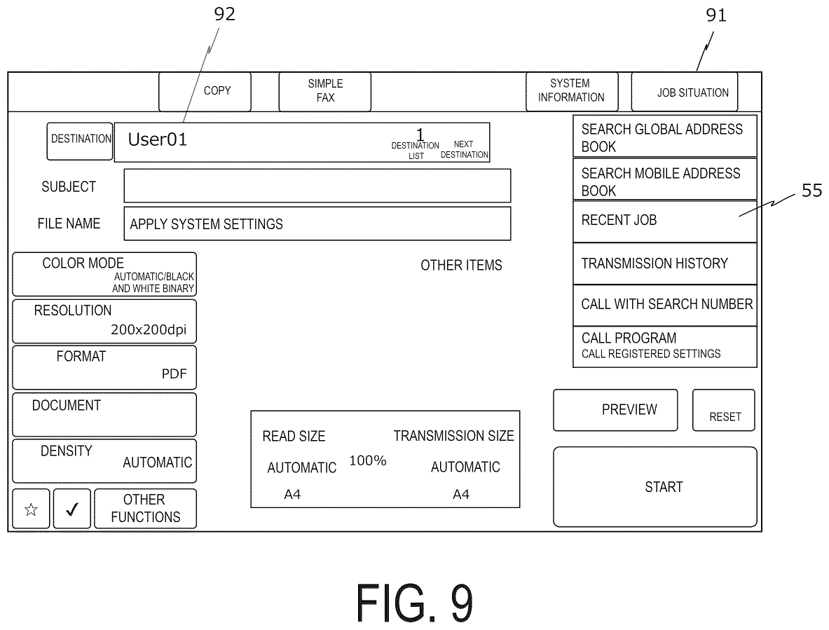

FIG. 9 illustrates an example of the image transmission basic screen with a selected history called and a registered destination applied. “User01”, which is the destination of the history selected in FIG. 8, is displayed in a destination field 92 on an image transmission basic screen 91 as illustrated in FIG. 9. As described above, even for a job for which the job prohibition setting has been established, the setting applier 12S enables reference to the history related to the job, and applies the setting of the destination and the like included in the selected history to the setting of the transmission job. However, even when the set transmission job is executed, the history storage processor 12H preferably does not store the destination of the job as a history in the history storage 13H.

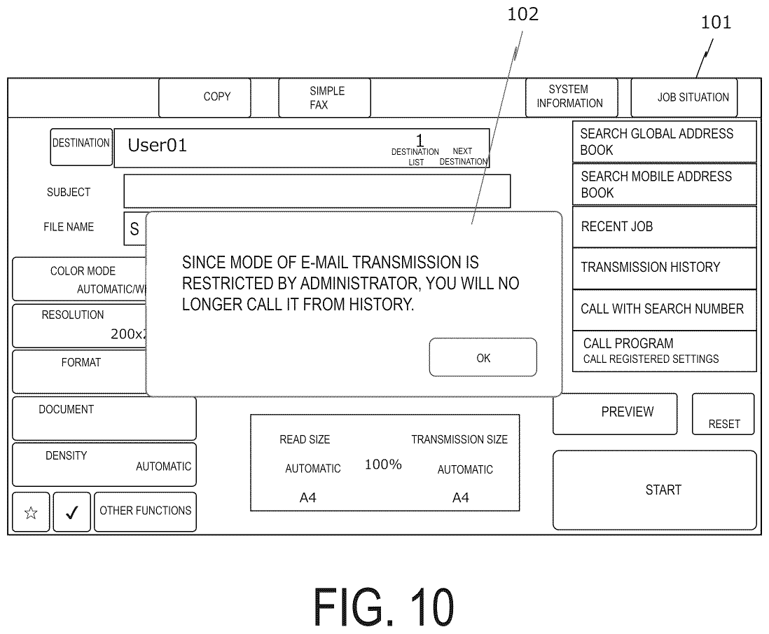

In a case in which the job prohibition setting is established, when the setting of the destination and the like included in the history of jobs for which the job prohibition setting has been established is applied to the setting of the transmission job, the user may be notified that the job has been set to be prohibited. FIG. 10 is a descriptive diagram illustrating an example of a message related to a job prohibition setting. The image transmission basic screen 101 illustrated in FIG. 10 is obtained by displaying a message 102 relating to the job prohibition setting on the image transmission basic screen 101 which is the same as the image transmission basic screen 91 illustrated in FIG. 9. A message 102 is displayed on the image transmission basic screen 101 displayed after the history relating to the transmission job in a mode for which job prohibition setting has been established is selected and called. An example of the contents is that, since the transmission job in this mode is restricted by the administrative user (the destination is not stored as a history even if the job is executed) as illustrated in FIG. 10, and eventually, the destination related to the transmission job of that mode will no longer be called from the history. According to this aspect, when an operation of applying the history to a job to be newly executed is performed after the job prohibition setting is established, the user who has performed the operation is notified of the fact that the job prohibition setting has been established, and thus it is possible to alleviate the limitation of the aspect in which the destination included in the history cannot be applied to the setting of the job without the user knowing after the job prohibition setting, and it is possible to reduce confusion of the user who does not know the establishment of the job prohibition setting.

### Second Embodiment

In the first embodiment, a transmission job in a mode for which a job prohibition setting has been established can be set and executed by applying a destination and the like included in a history only when transmission jobs in the same mode are stored in the history. In the present embodiment, although the setting and execution of the job to which a destination and the like included in a history are applied are enabled until a predetermined period (available period) elapses after the job prohibition setting is performed, the transmission job for which the destination and the like included in the history are applied to the setting is not executed when the available period elapses. The available period may be set by the administrative user upon accepting the job prohibition setting.

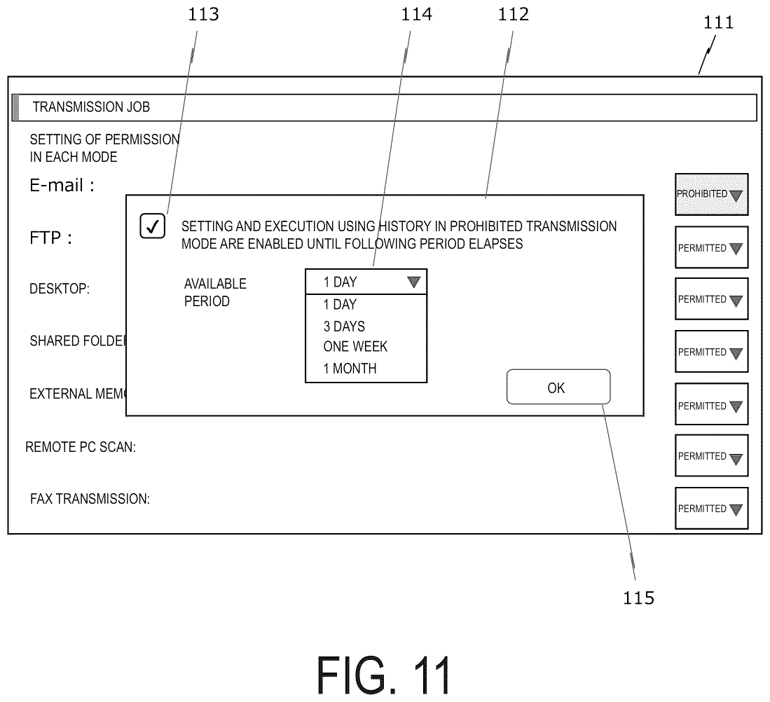

FIG. 11 is a descriptive diagram illustrating an example of a screen for setting an available period according to the present embodiment. As illustrated in FIG. 11, when a transmission job in any mode is set to be prohibited on a job restriction screen 111, the period setting screen 112 is displayed on the job restriction screen 111 where the prohibition was set in an overlapping manner. A period setting screen 112 includes a checkbox 113 for setting activation/inactivation of the available period and a period selection menu 114 for selecting an available period. The period selection menu 114 illustrated in FIG. 11 is a drop-down menu for selecting any of a plurality of periods prepared in advance, but is not limited thereto, and an arbitrary value may be input. Check marks are turned on and off each time the checkbox 113 is touched. When an “OK” button 115 is touched with the checkbox 113 checked, the setting manager 12C sets the available period selected on the period selection menu 114 to be activated. In the example of FIG. 11, the available period of the e-mail transmission job for which the job prohibition setting has been established is set to one day. Therefore, although the setting of an e-mail transmission job to which a destination included in the history has been applied and execution of the job are enabled until the next day of the establishment of the job prohibition setting, it is prohibited to select and call the history to set a destination and the like after the next day, and the e-mail transmission job cannot be executed at all.

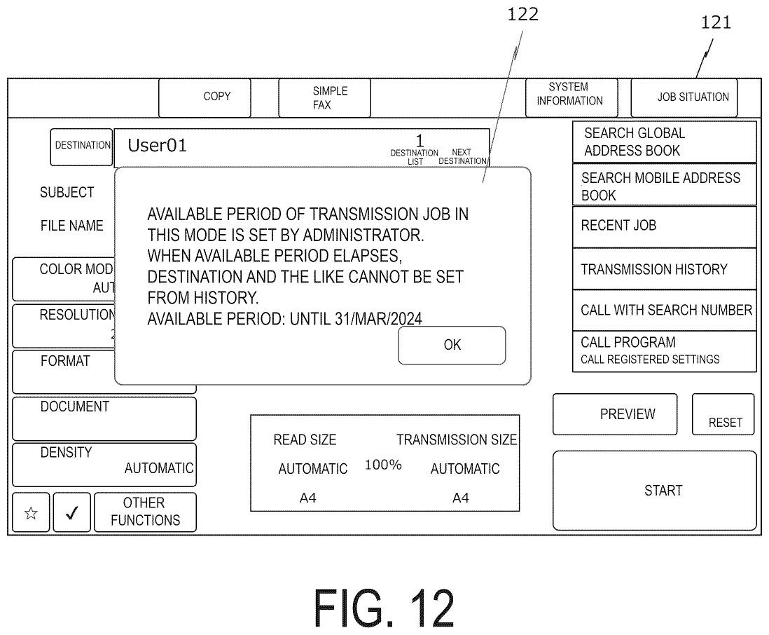

FIG. 12 is a descriptive diagram illustrating an example of a message displayed on the image transmission basic screen during a period until the available period elapses when an available period is set, in which a setting of a job to which the setting of a destination and the like included in the history has been applied and execution of the job are enabled in the present embodiment. The message 122 shown in FIG. 12 is displayed on an image transmission basic screen 121 in an overlapping manner after the history of the transmission job in the mode in which the job prohibition setting has been established is selected and called. As an example of the content, since the transmission job in this mode is restricted by the administrative user, the destination from the history cannot be set when the available period elapses as illustrated in FIG. 12. At the same time, the available period set on the screen of FIG. 11 is displayed. According to the present embodiment, when a specific user such as an administrative user of the device establishes a job prohibition setting to prohibit execution of a job in any communication method, it is possible to execute a job in the communication method for which the job prohibition setting has been established by applying the history for a predetermined period even after the job prohibition setting is established, so it is possible to alleviate the limitation of the aspect in which the setting of a destination and the like included in the history cannot be immediately applied to a job setting after the job prohibition setting is established, and it is possible to reduce confusion of the user who does not know the establishment of the job prohibition setting.

### Third Embodiment

In the second embodiment, the aspect in which a job can be set and executed by applying settings of a destination and the like included in a history until a predetermined period (available period) elapses after a job prohibition setting is established has been described. In the present embodiment, an aspect in which a deadline is set instead of the available period of the second embodiment, the deadline enabling a job setting to which a setting of a destination and the like included in a history is applied and job execution, will be described. According to the present embodiment, a setting of a job to which the setting of the destination and the like included in the history is applied and the execution of the job are enabled until the set deadline arrives after the job prohibition setting is established, but the transmission job for which the setting of the destination and the like included in the history is applied to the setting of the job is not executed when the deadline elapses. The deadline may be set by the administrative user upon accepting the job prohibition setting.

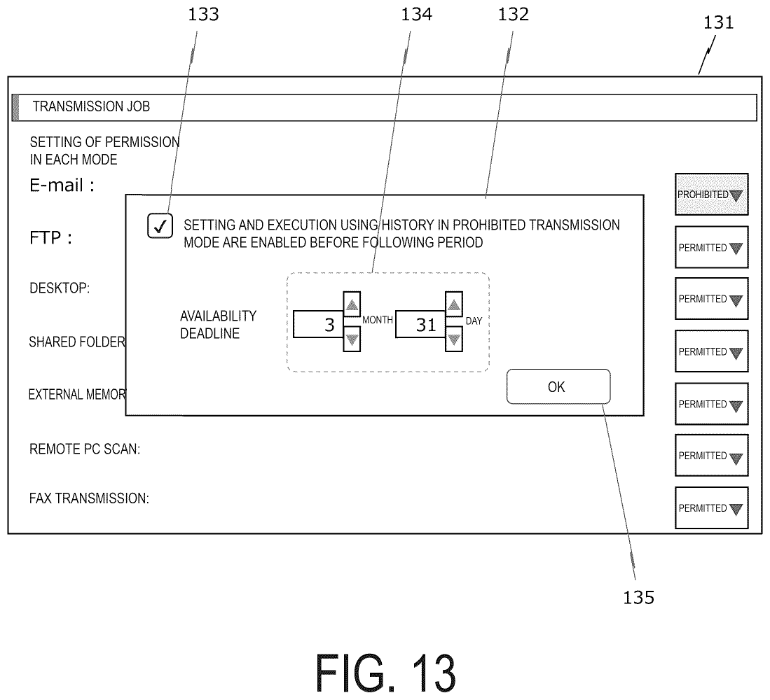

FIG. 13 is a descriptive diagram illustrating an example of a screen for setting the above-mentioned deadline according to the present embodiment. As illustrated in FIG. 13, when a transmission job in any mode is set to be prohibited on a job restriction screen 131, the deadline setting screen 132 is displayed on a job restriction screen 131 where the prohibition was set in an overlapping manner. The deadline setting screen 132 includes a checkbox 133 for setting activation/inactivation of an availability deadline and a deadline setting area 134 for setting a deadline. The setting manager 12C turns on and off check marks each time the checkbox 133 is touched. When an “OK” button 135 is touched with the checkbox 133 checked, the deadline set in a deadline setting area 134 becomes activated. In the example of FIG. 13, the deadline of the e-mail transmission job for which the job prohibition setting has been established has been set to March 31. Thus, until March 31 arrives after the job prohibition setting is established, a setting of an e-mail transmission job to which the setting of the destination and the like included in the history is applied and execution of the job are enabled. However, if March 31 passes, the setting of the destination and the like by selecting and calling the history is prohibited, and execution of the e-mail transmission job for setting the destination and the like from the history is disabled.

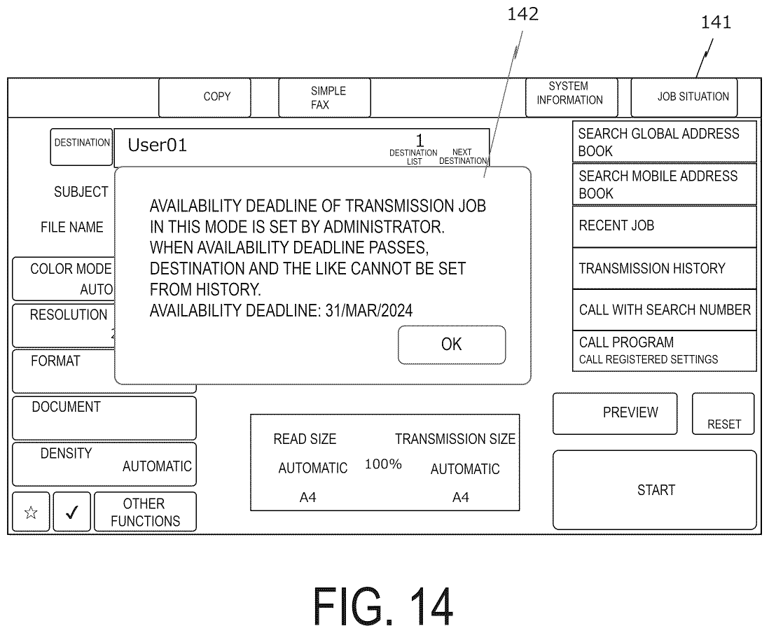

FIG. 14 is a descriptive diagram illustrating an example of a message displayed on the image transmission basic screen during a period until the deadline arrives when the deadline is set, in which a setting of a job to which the setting of a destination and the like included in the history has been applied and execution of the job are enabled in the present embodiment. The message 142 shown in FIG. 14 is displayed on an image transmission basic screen 141 in an overlapping manner after the history of the transmission job in the mode in which the job prohibition setting has been established is selected and called. As an example of the content, since the transmission job in this mode is restricted by the administrative user, the destination from the history cannot be set when the availability deadline elapses as illustrated in FIG. 14. At the same time, the deadline set on the screen of FIG. 13 is displayed. According to the present embodiment, when a specific user, for example, an administrative user of the device, has established a job prohibition setting to prohibit execution of a job in any communication method, it is possible to execute a job in the communication method for which the job prohibition setting has been established by applying the history until the set deadline arrives, so it is possible to alleviate the limitation of the aspect in which the setting of a destination and the like included in the history cannot be immediately applied to a job setting after the job prohibition setting, and it is possible to reduce confusion of the user who does not know the establishment of the job prohibition setting.

### Fourth Embodiment

In the second embodiment, the aspect in which a job can be set and executed by applying settings of a destination and the like included in a history until a predetermined period (available period) elapses after a job prohibition setting is established has been described. In the present embodiment, an aspect of setting, instead of the available period of the second embodiment, the number of times in which a setting of a job, to which a setting of a destination and the like included in a history has been applied, and execution of the job are enabled, will be described. In the present embodiment, although the setting of the job to which a destination and the like included in a history are applied and execution of the job are enabled until a predetermined number of times (number of available times) is reached after the job prohibition setting is performed, the transmission job for which a setting of the destination and the like included in the history is applied to the setting of the job is not executed when the number of available times exceeds. The number of available times may be set by the administrative user upon accepting the job prohibition setting.

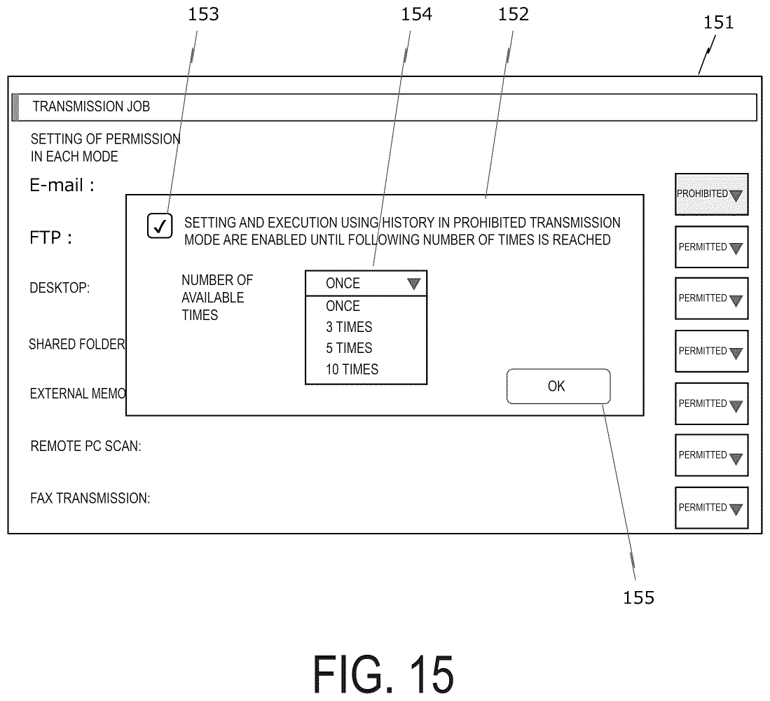

FIG. 15 is a descriptive diagram illustrating an example of a screen for setting the number of available times according to the present embodiment. As illustrated in FIG. 15, when a transmission job in any mode is set to be prohibited on a job restriction screen 151, a number-of-times setting screen 152 is displayed on the job restriction screen 151 where the prohibition was set in an overlapping manner. The number-of-times setting screen 152 includes a checkbox 153 for setting activation/inactivation of the number of available times and a number-of-times selection menu 154 for selecting the number of available times. The number-of-times selection menu 154 illustrated in FIG. 15 is a drop-down menu for selecting any of a plurality of options prepared in advance, but is not limited thereto, and an arbitrary value may be input. The setting manager 12C turns on and off check marks each time the checkbox 153 is touched. When an “OK” button 155 is touched with the checkbox 153 checked, the number of available times selected on the number-of-times selection menu 154 is activated. In the example of FIG. 15, the number of available times of the e-mail transmission job for which the job prohibition setting has been established is set to once. Therefore, although setting of an e-mail transmission job to which a setting of a destination and the like included in the history has been applied and execution of the job are enabled at one time after the establishment of the job prohibition setting, it is prohibited to select and call the history to set a destination and the like at the second time and thereafter, and the e-mail transmission job cannot be executed at all.

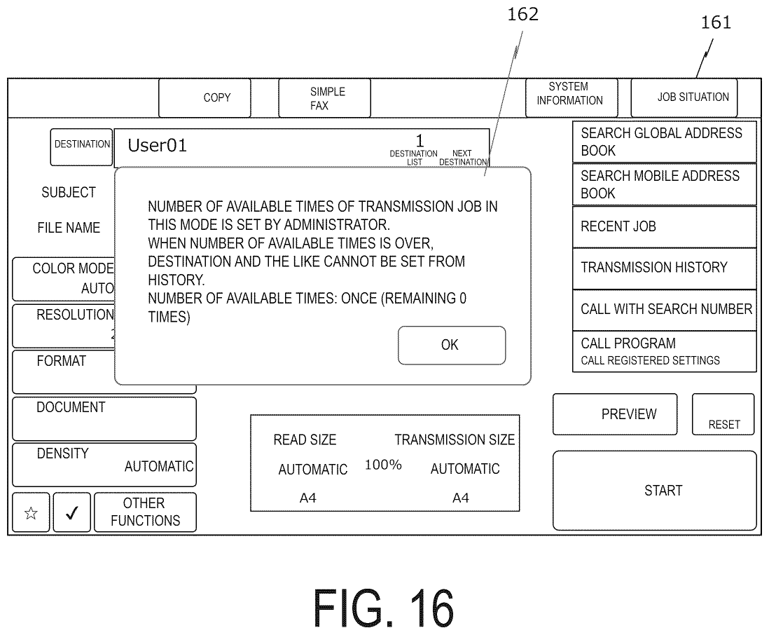

FIG. 16 is a descriptive diagram illustrating an example of a message displayed on the image transmission basic screen during a period until the number of available times is over when the number of available times is set, in which a setting of a job to which the setting of a destination and the like included in the history has been applied and execution of the job are enabled in the present embodiment. The message 162 shown in FIG. 16 is displayed on an image transmission basic screen 161 in an overlapping manner after the history of the transmission job in the mode in which the job prohibition setting has been established is selected and called. In an example with the above details, since the transmission job in this mode is restricted by the administrative user as illustrated in FIG. 16, the destination from the history cannot be set when the number of available times is over. At the same time, the number of available times set on the screen of FIG. 15 is displayed. At this time, the remaining number of available times may be displayed together. According to the present embodiment, when a specific user, for example, an administrative user of the device, has established a job prohibition setting to prohibit execution of a job in any communication method, it is possible to execute a job in the communication method for which the job prohibition setting has been established by applying the history until the set number of available times is reached, so it is possible to alleviate the limitation of the aspect in which the setting of a destination and the like included in the history cannot be immediately applied to a job setting after the job prohibition setting, and it is possible to reduce confusion of the user who does not know the establishment of the job prohibition setting. For example, this aspect may be combined with an aspect of accepting a setting of the available period or the deadline. For example, after the job prohibition setting, the history may be applicable to a new execution job of a communication method for which the prohibition setting has been established until any one of conditions that the available period or the set deadline (availability deadline) is reached or that the number of available times is reached.

### Fifth Embodiment

In the present embodiment, for a transmission job in a mode in which the job prohibition setting has been established, if permission is applied for and obtained from the administrative user each time, a setting of a job to which the setting of the destination and the like included in the history is applied and execution of the job are enabled. The job controller 12J puts the transmission job for which permission has been applied in a job execution waiting queue until the permission is obtained, and other jobs can be executed during that time. The application destination (for example, a destination such as an e-mail address of the administrative user) to which permission has been applied may be set by the administrative user upon accepting the job prohibition setting.

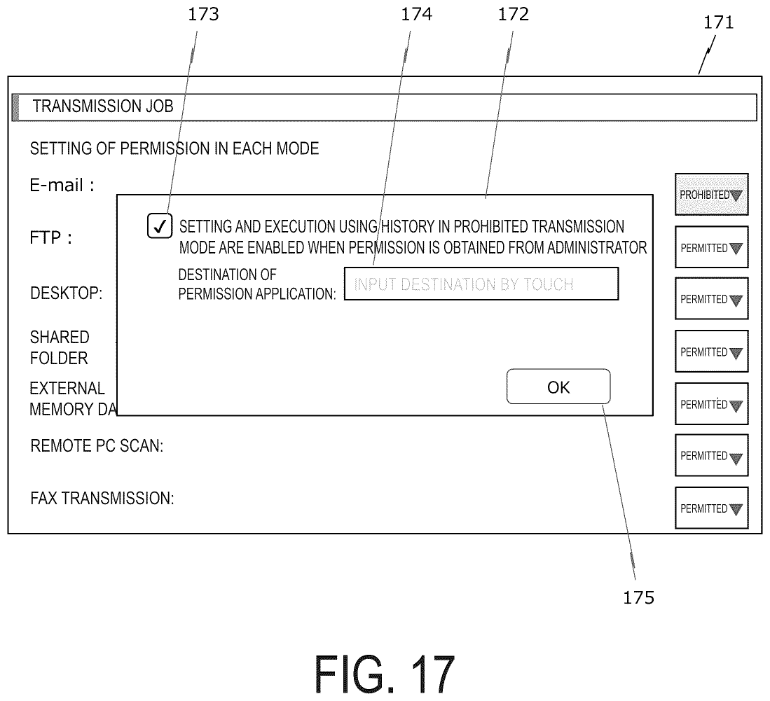

FIG. 17 is a descriptive diagram illustrating an example of a screen for setting a permission application to an administrative user according to the present embodiment. As illustrated in FIG. 17, when a transmission job in any mode is set to be prohibited on a job restriction screen 171, an application setting screen 172 is displayed on the job restriction screen 171 where the prohibition was set in an overlapping manner. The application setting screen 172 includes a checkbox 173 for setting whether to file a permission application to the administrative user, and an application destination setting field 174 for setting a transmission destination of the permission application to the administrative user. The application destination setting field 174 illustrated in FIG. 17 is assumed to receive direct input of a transmission destination using a software keyboard, which is not illustrated, or the like, but the configuration is not limited thereto, and for example, a destination received from an external device such as a mobile terminal may be set. The setting manager 12C turns on and off check marks each time the checkbox 173 is touched.

When an “OK” button 175 is touched with the checkbox 173 checked, the setting to transmit the permission application to the administrative user is confirmed. After the setting, when the user attempts to set a transmission job to which the job prohibition setting has been established by applying a setting of a destination and the like included in a history, the job controller 12J puts the transmission job in a job execution waiting queue until permission is obtained, and transmits the permission application to the transmission destination set in the application destination setting field 174. The transmission destination is, for example, a destination of an e-mail transmission toward the administrative user. Upon receiving a reply indicating permission from the administrative user for the e-mail for the permission application, the job controller 12J, in response to the reply, applies the setting of the destination and the like included in the history to the setting of the destination and the like of the target transmission job in the queue.

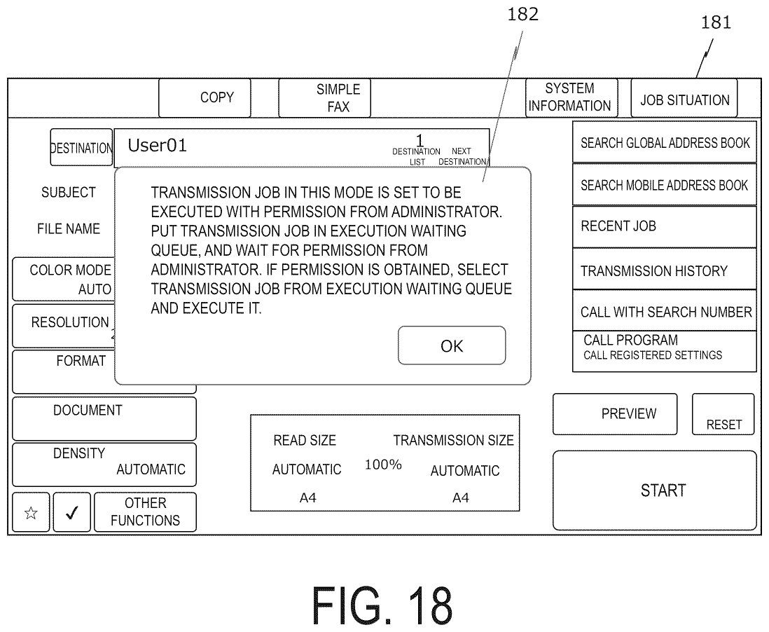

FIG. 18 is a descriptive diagram illustrating an example of a message displayed on an image transmission basic screen when it is intended to set a transmission job for which a job prohibition setting has been established by applying a setting of a destination and the like included in a history in the present embodiment. The message 182 shown in FIG. 18 is displayed on an image transmission basic screen 181 in an overlapping manner after the history of the transmission job in the mode in which the job prohibition setting has been established is selected and an operation of calling a setting of a destination and the like included in the history is performed. In an example with the above details, since the transmission job in this mode is set to be executed under permission from the administrative user as illustrated in FIG. 18, the job is put in the job execution waiting queue and the permission is obtained from the administrative user. Furthermore, if permission is obtained from the administrative user, the operation of selecting the transmission job in the job execution waiting queue for execution is performed. When the reply of permission is obtained from the administrative user within a predetermined period, the job controller 12J displays a message indicating the fact on the operation screen (not illustrated). The transmission job in the job execution waiting queue can be selected and executed. On the other hand, upon receiving a reply indicating that no permission was obtained from the administrative user, the job controller 12J displays a message indicating the fact (not illustrated), and deletes the target transmission job from the job execution waiting queue. If no reply is received from the administrator within a predetermined period, a message indicating the fact is displayed (not illustrated), and the target transmission job is deleted from the job execution waiting queue.

According to the present embodiment, when a user is notified that permission of the administrative user is necessary and permission is obtained from the administrative user, it is possible to execute a job in a communication method for which a job prohibition setting has been established by applying the setting of the destination and the like included in the history. Therefore, it is possible to alleviate the limitation of the aspect in which the setting of the destination and the like included in the history of jobs cannot be uniformly applied to the setting of the job after the job prohibition setting, and it is possible to reduce confusion of the user who does not know the establishment of the job prohibition setting. The condition for sending a permission application to the administrative user may be limited by any one of the available period after the job prohibition setting, the availability deadline, and the number of available times, for example. As another aspect, after the conditions of the available period, the availability deadline, and the number of available times are met, a notification for obtaining permission by applying this aspect may be sent.

### Flowchart

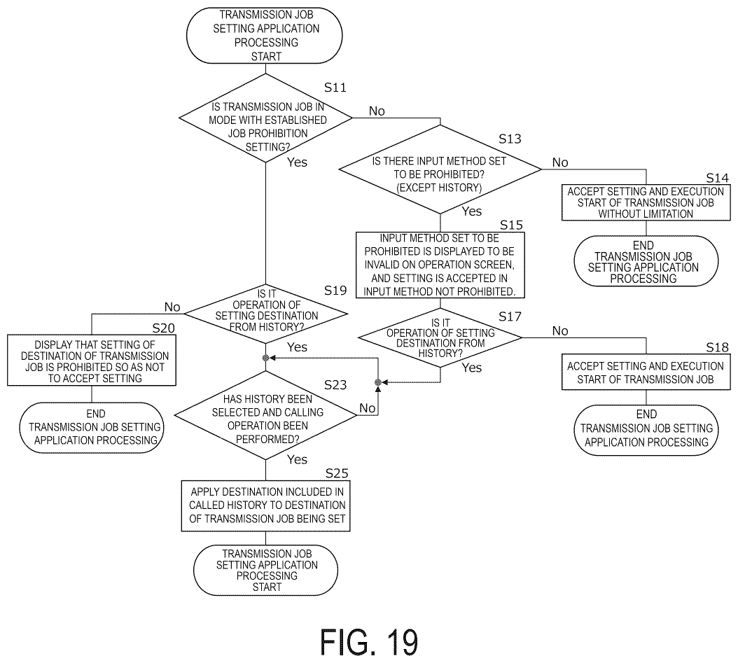

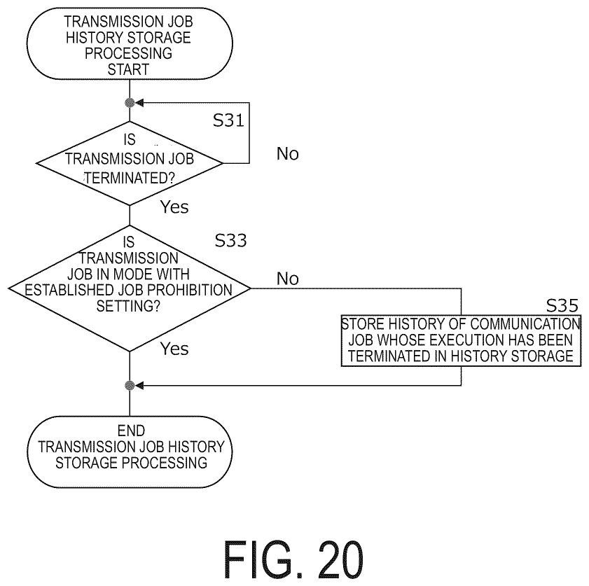

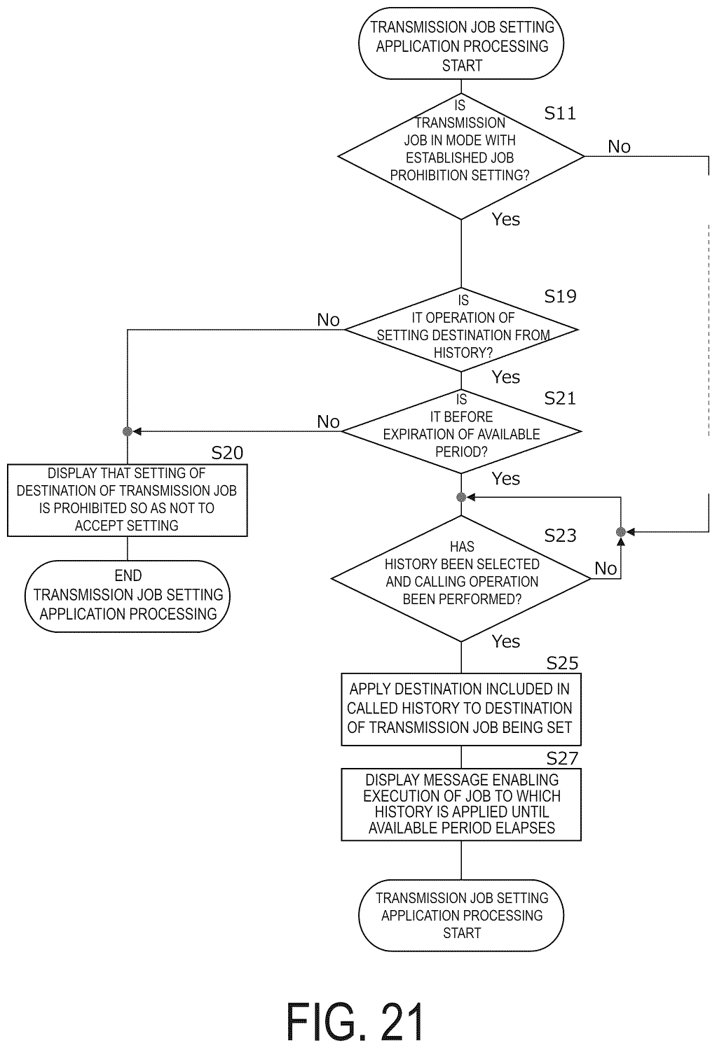

The flow of processing executed by the controller 12 in the first to fifth embodiments will be described below with reference to a flowchart. FIG. 19 is a flowchart illustrating an example of the flow of processing executed by the controller 12 serving as the setting applier 12S in the first embodiment. FIG. 20 is a flowchart illustrating an example of the flow of processing executed by the controller 12 serving as the history storage processor 12H in the first embodiment. FIG. 21 is a flowchart illustrating an example of processing different from the processing performed by the controller 12 in FIG. 19 in the second embodiment.

As illustrated in FIG. 19, when the controller 12 serving as the setting applier 12S accepts an operation of setting a transmission job, the controller 12 determines whether the setting is related to a transmission job in a mode in which a job prohibition setting has been established (step S11). This is a job prohibition setting made on the job restriction screen 31 illustrated in FIG. 3. If the mode is not a mode in which the job prohibition setting has been established (No in step S11), the controller 12 subsequently determines whether any input method is set to be prohibited for the transmission job whose setting is to be accepted (step S13). This is a prohibition setting made on the input method restriction screen 41 illustrated in FIG. 4. As described above, there is no setting to prohibit an input method that applies a destination included in a history other than a transmission history. If no input methods are prohibited (No in step S13), the setting of the transmission job is accepted without any restriction. Furthermore, an instruction to start execution of the set transmission job is accepted (step S14). Then, the processing is terminated.

In the determination of step S13 described above, when any of the input methods is set to be prohibited (Yes in step S13), the controller 12 subsequently displays that the input method set to be prohibited is not allowed to be input on the operation screen, and accepts the setting by using an input method that is not prohibited. For example, if the input using the address book is set to be prohibited, the “address book” button 53 on the image transmission basic screen 51 illustrated in FIG. 5A is grayed out to be deactivated, and no operation is accepted. For example, when input using a transmission history is set to be prohibited, the “transmission history” button 52 on the image transmission basic screen 51 is not displayed, and the “transmission history” button 52 will not be operated. Then, a setting based on the input method set not to be prohibited is accepted. The input method set not to be prohibited includes a method of applying a setting of a destination and the like included in a history to the setting. The controller 12 determines whether an operation of applying the setting of the destination and the like included in the history to the setting of a job has been performed (step S17). If the operation related to the setting is not to apply the setting of the destination and the like included in the history (No in step S17), the setting of the transmission job is accepted, and an instruction to start the execution of the set transmission job is accepted (step S18). Then, the processing is terminated. In the determination of step S17 described above, if the operation related to the setting is to apply the setting of the destination and the like included in the history (Yes in step S17), the processing proceeds to step S23 described below, and the operation of selecting and calling the history is awaited to be performed.

In the determination of step S11 described above, if it is determined that the accepted operation is the setting related to the transmission job in the mode in which the job prohibition setting has been established (Yes in step S11), the controller 12 determines whether an operation of applying the setting of the destination and the like included in the history to the setting of the job has been performed (step S19). If the operation related to the setting of the job is not to apply the setting of the destination and the like included in the history (No in step S19), the fact that the setting of the destination of the transmission job is prohibited is displayed on the operation screen to prevent the setting from being accepted (step S20). Then, the processing is terminated. On the other hand, if the operation related to the setting of the job is to apply the setting of the destination and the like included in the history (Yes in step S19), the controller 12 awaits the operation of selecting and calling the history to be performed (step S23). If the operation of selecting and calling the history is accepted (Yes in step S23), the controller 12 applies the setting of the destination and the like included in the called history to the setting of the destination and the like of the transmission job being set (step S25), and terminates the processing. The above configuration is the flow of the processing by the setting applier 12S.

Next, a flow of processing by the controller 12 as the history storage processor 12H will be described. FIG. 20 is a flowchart illustrating an example of the flow of processing executed by the controller 12 serving as the history storage processor 12H. As illustrated in FIG. 20, the controller 12 serving as the history storage processor 12H awaits the termination of the transmission job that has started being executed (step S31). If the execution of the transmission job is terminated (Yes in step S31), the controller 12 determines whether the terminated transmission job is a transmission job in the mode in which the job prohibition setting has been established (step S33). If it is a transmission job in a mode in which the job prohibition setting has not been established (No in step S33), the history related to the transmission job of which execution has been terminated is stored in the history storage 13H (step S35). Then, the processing is terminated. On the other hand, if it is the transmission job in the mode in which the job prohibition setting has been established (Yes in step S33), the processing is terminated without storing the history related to the transmission job of which execution has been terminated in the history storage 13H. In this way, the controller 12 stores the history only of the transmission job in the mode in which the job prohibition setting has not been established, and does not store the history of the transmission job in the mode in which the job prohibition setting has been established. The above configuration is the flow of the processing by the history storage processor 12H.

The flow of processing according to the first embodiment has been described above, and the flow of processing according to the second embodiment will be described below mainly in terms of differences from the first embodiment. FIG. 21 is a flowchart illustrating the differences of the processing executed by the controller 12 in the second embodiment from the processing of FIG. 19 according to the first embodiment. The flowchart of FIG. 21 corresponds to FIG. 19, and the same reference numerals (step numbers) are given to the same processing. In addition, a part of the same processing as that in FIG. 19 is omitted and indicated by a chain line. The differences of the flowchart of FIG. 21 from that of FIG. 19 is the processing of step S21 and the processing of step S27. The flow of processing of the differences will be described below.

In the determination of step S11, if it is determined that the accepted operation is the setting related to the transmission job in the mode in which the job prohibition setting has been established (Yes in step S11) as in FIG. 19, the controller 12 determines whether an operation of applying the setting of the destination and the like included in the history to the setting of the job has been performed (step S19). If the operation related to the setting of the job is not to apply the setting of the destination and the like included in the history (No in step S19), the fact that the setting of the destination of the transmission job is prohibited is displayed on the operation screen to prevent the setting from being accepted (step S20). Then, the processing is terminated.

On the other hand, if the operation related to the setting of the job is to apply the setting of the destination and the like included in the history (Yes in step S19), the controller 12 subsequently determines whether the set available period has not expired (step S21). If the available period has expired (No in step S21), the fact that the available period has expired and the setting of the destination of the transmission job is prohibited is displayed on the operation screen, and the setting is not accepted (step S20). Then, the processing is terminated. On the other hand, if the available period has not yet expired (Yes in step S21), the operation of selecting and calling the history is awaited to be performed (step S23). If the operation of selecting and calling the history is accepted (Yes in step S23), the controller 12 applies the setting of the destination and the like included in the called history to the setting of the destination and the like of the transmission job being set (step S25). Furthermore, after the available period is set, a message indicating that the setting of the job to which the setting of the destination and the like included in the history has been applied and the execution of the job are enabled until the available period elapses is displayed on the operation screen (step S27). It is the message 122 illustrated in FIG. 12. Then, the processing is terminated. The above configuration is the flow of the processing of the controller 12 serving as the setting applier 12S in the second embodiment.

In the second embodiment, the flow of processing by the history storage processor 12H is the same as that in the first embodiment, and thus a flowchart thereof is omitted. Furthermore, the flow of the processing of third to fifth embodiments can be understood by those skilled in the art based on the flow of the processing of the second embodiment.

It should be understood that the present disclosure also includes combinations of any of the aforementioned plurality of aspects.

Various modifications of the disclosure are also possible as well as the aforementioned embodiments. It should not be understood that the modifications do not belong to the scope of the disclosure. The present disclosure should include all modifications belonging to the meaning equivalent to the scope of the claims and the scope of the present disclosure.

### DESCRIPTION OF REFERENCE CHARACTERS

10: Image communication apparatus, 11: Operation inputter, 12: Controller, 12C: Setting manager, 12H: History storage processor, 12J: Job controller, 12P: Image controller, 12R: Input acceptor, 12S: Setting applier, 12U: Operation controller, 13: Memory, 13H: History storage, 14: Image processor, 14E: Engine unit, 14F: Document feeding device, 14P: Feeder, 14S: Scanner unit, 14X: Sheet discharger, 15: Communication circuit, 31, 111, 131, 151, 171: Job restriction screen, 41: Input method restriction screen, 42: Transmission history input prohibition setting, 43: Address book input prohibition setting, 44: Direct input prohibition setting, 51, 91, 101, 121, 141, 161, 181: Image transmission basic screen, 52: “Transmission history” button, 53: “Address book” button, 54, 92: Destination field, 55: “Recent job” button, 56: Job setting area, 57: “Start” button, 58: Message, 61: Destination selection screen, 62: Address book display area, 63: “Narrow-down_all” button, 71: Transmission mode selection screen, 72: Mode selection area, 81: History screen, 82: History display area, 83: Job type selection unit, 84: Selected history display area, 85: “Call” button, 102, 122, 142, 162, 182: Message, 112: Period setting screen, 113, 133, 153, 173: Checkbox, 114: Period selection menu, 115, 135, 155, 175: “OK” button, 132: Deadline setting screen, 134: Deadline setting area, 152: Number-of-times setting screen, 154: Number-of-times selection menu, 172: Application setting screen, 174: Application destination setting field.

1. An image communication apparatus, comprising:
one or more job controllers that control execution of a job of transmitting image data, based on a setting by a user, in a communication method selected by the user from a plurality of communication methods;
a history storage processor that stores a history of an executed job in a memory;
a setting applier that accepts selection of any history and applies a setting included in the selected history to a new execution job to enable the job to be executed; and
a setting manager that accepts, from a specific user, a job prohibition setting to prohibit execution of the job in any of the communication methods,
wherein, when any history is selected even in a case where the job prohibition setting has been established, the setting applier applies a setting included in the history to enable the new execution job to be executed.

2. The image communication apparatus according to claim 1, further comprising:
an input acceptor that accepts a destination setting related to the new execution job from a plurality of input methods,
wherein the input acceptor accepts application of the history by the setting applier as one of the input methods to accept the destination setting related to the new execution job, and
when accepting, from the specific user, a prohibition setting to prohibit the destination setting by any of the input methods, the setting manager can accept a setting that a destination setting, to which the history has been applied by the setting applier, is not an input method to be prohibited.

3. The image communication apparatus according to claim 1,
wherein the setting included in the history includes a destination of the transmission, and the memory stores the history in a first-in-first-out manner.

4. The image communication apparatus according to claim 1,
wherein the setting manager accepts a setting of an available period indicating a predetermined period in applying the setting included in the history to the new execution job, and
the setting applier enables the setting included in the history to be applied to the new execution job until the available period elapses after the job prohibition setting is established, but disables the setting included in the history from being applied to the new execution job after the available period elapses.

5. The image communication apparatus according to claim 1,
wherein the setting manager accepts a setting of a deadline in applying the setting included in the history to the new execution job, and
the setting applier enables the setting included in the history to be applied to the new execution job until the deadline arrives after the job prohibition setting is established, while disabling the setting included in the history from being applied to the new execution job after the deadline arrives.

6. The image communication apparatus according to claim 1,
wherein the setting manager accepts a setting of the number of available times indicating a predetermined number of times in applying the setting included in the history to the new execution job, and
the setting applier enables the setting included in the history to be applied to the new execution job until the number of available times is reached after the job prohibition setting is established, while disabling the setting included in the history from being applied to the new execution job after the number of available times is reached.

7. The image communication apparatus according to claim 1,
wherein the setting manager accepts a setting of a notification destination to obtain a permission from a predetermined administrator in applying the setting included in the history to the new execution job, and
the setting applier enables the setting included in the history to be applied to the new execution job when a notification to obtain the permission has been sent to the notification destination and a permission to the notification has been obtained, while disabling the setting included in the history from being applied to the new execution job when no permission has been obtained.

8. The image communication apparatus according to claim 1, wherein, when the new execution job is executed, the history storage processor does not store, in the memory, a history of a job related to a communication method for which the job prohibition setting has been established.

9. The image communication apparatus according to claim 1,
wherein, when the new execution job is executed, the history storage processor stores a history of a job related to a communication method for which the job prohibition setting has not been established, and
the setting applier applies a setting included in the history to the new execution job regardless of whether the job prohibition setting has been established.

10. The image communication apparatus according to claim 1, wherein, when the job prohibition setting has been established for a job related to any communication method, the setting applier notifies a user that the job prohibition setting has been established.

11. A job setting method comprising, by one or more controllers that control an image communication apparatus:
controlling execution of a job of transmitting image data, based on a setting by a user, in a communication method selected by the user from a plurality of communication methods;
storing a history of an executed job in a memory;
accepting selection of any history and applying a setting included in the selected history to a new execution job to enable the job to be executed; and
accepting, from a specific user, a job prohibition setting to prohibit execution of the job in any of the communication methods,
wherein, in the applying of the setting, when any history is selected even in a case where the job prohibition setting has been established, a setting included in the history is applied to enable the new execution job to be executed.
